(19) United States
(12) Patent Application Publication
(10) Pub. No.: US 2020/0335921 A1
(43) Pub. Date: Oct. 22, 2020

(54) GROUNDING MEMBER FOR COAXIAL CABLE CONNECTOR

(71) Applicant: PPC BROADBAND, INC., East Syracuse, NY (US)

(72) Inventors: Noah P. MONTENA, Syracuse, CT (US); Robert M. PARKER, Aurora, CO (US)

(73) Assignee: PPC BROADBAND, INC., East Syracuse, NY (US)

(21) Appl. No.: 16/922,992

(22) Filed: Jul. 7, 2020

Related U.S. Application Data
(63) Continuation of application No. 15/650,521, filed on Jul. 14, 2017, now Pat. No. 10,707,629.
Application No. 15/650,521 is a continuation of application No. 14/920,150, filed on Oct. 22, 2015, now Pat. No. 9,711,917.
Application No. 14/920,150 is a continuation-in-part of application No. 13/479,123, filed on May 23, 2012, now Pat. No. 9,203,167.
(60) Provisional application No. 61/490,373, filed on May 26, 2011.

(51) Int. Cl. H01R 24/38; H01R 9/05

(52) U.S. Cl. CPC H01R 24/38; H01R 2103/00; H01R 9/05

(57) ABSTRACT

A connector including coupling and sleeve flanges defining opposing recesses separated by an axial gap along an elongate axis. The connector also includes a arcuate bridge member radially biased outwardly against at least one of the internal contact surfaces of the opposing recesses and spanning the axial gap. The arcuate bridge member maintains electrical conductivity across the axial gap even when the sleeve does not electrically contact the coupling member. At least one of the contact surfaces defines a conical surface which is responsive to the radially biased conductive bridge member to produce a radial force against the internal contact surfaces. The radial force produces an axial force component along the elongate axis.

### CROSS-REFERENCE TO RELATED APPLICATIONS

This is a continuation of U.S. application Ser. No. 15/650,521, filed on Jul. 14, 2017, pending, which is a continuation of U.S. application Ser. No. 14/920,150, filed on Oct. 22, 2015, entitled “BAND SPRING CONTINUITY MEMBER FOR COAXIAL CABLE CONNECTOR,” now U.S. Pat. No. 9,711,917, which is a continuation-in-part of U.S. application Ser. No. 13/479,123, filed on May 23, 2012, entitled “COAXIAL CABLE CONNECTOR WITH CONDUCTIVE SEAL,” now U.S. Pat. No. 9,203,167, which claims the benefit of U.S. Provisional Patent Application No. 61/490,373, filed on May 26, 2011. The entire contents of such applications are hereby incorporated by reference in their em

### BACKGROUND

The present disclosure relates to cable connectors; and more particularly, to a new and improved connector for connecting a coaxial cable to a RF device, such as, a home entertainment s television set, or other device.

### SUMMARY

The present disclosure is directed to a connector including a post, a sleeve or body member, and a coupling member each having a flange member, The flange members of the sleeve and coupling member have recesses each defining an internal contact surface separated by an axial gap. The connector also includes an arcuate bridge member radially biased outwardly against at least one of the internal contact surfaces and spanning the axial gap. The arcuate bridge member maintains an electrical ground path across the axial gap even when the sleeve does not electrically contact the coupling member.

Another embodiment of the connector relates to a coaxial cable connector wherein the recesses include at least one conical surface which is responsive to a radially biased conductive bridge member o produce a radial force against the internal contact surfaces such that an axial force component is generated along the conical surface. The conductive bridge member spans the axial gap so as to maintain an electrical ground path across the axial gap even when the sleeve does not electrically contact the coupling member. Furthermore, the conductive bridge member constantly biases the flange of the coupling member against the flange of the post to urge the post against an interface port.

In one embodiment the conductive bridge member is an arcuate bridge member having an outwardly directed contact surface complementing the conical surface of the internal contact surface. In another embodiment, the conductive bridge member is a coil spring having a diameter dimension which is oversized relative to the size of the recesses such that when the connector is in an assembled state, the coil spring deforms radially such that an axial component of force is produced. Specifically, the axial component is produced by the interaction of the coil spring with the conical surface of the coupling member.

Another embodiment relates to a coaxial cable connector wherein a sealing member is disposed between the flange of the post and the inwardly directed flange of the coupling member.

### BRIEF DESCRIPTION OF THE DRAWINGS

The present disclosure will become more readily appreciated and understood from consideration of the following detailed description of various embodiments of the present invention when taken together with the accompanying drawings, in which:\

FIG. 1 is a longitudinal section view of one embodiment with a cable and seal in a loosely assembled position;

FIG. 2 is an enlarged view in section of the conductive seal of FIG. 1 in a loosely assembled position prior to installation according to an exemplary embodiment;

FIG. 3 is another enlarged sectional view in detail of the conductive seal of FIG. 1 in a fully tightened position according to an exemplary embodiment;

FIG. 4 is a longitudinal sectional view of another embodiment utilizing a conductive spring member and illustrating the cable in an assembled position;

FIG. 5 is a cross-sectional view taken about lines 5-5 of FIG. 4 according to an exemplary embodiment;

FIG. 6 is an enlarged view in detail of the spring member of FIG. 4 shown in a tightly assembled position according to an exemplary embodiment;

FIG. 7 is another sectional view in detail of the spring member of FIG. 4 in a loosely assembled position according to an exemplary embodiment;

FIG. 8 is a longitudinal section view of still another embodiment utilizing a flat spring as a conductive bridge member and being shown in a fully assembled position;

FIG. 9 is a cross-sectional view taken about lines 9-9 of FIG. 8 according to an exemplary embodiment;

FIG. 10 is an enlarged sectional view in detail of the seal and spring in a tightly assembled position according to an exemplary embodiment; and

FIG. 11 is another enlarged sectional view in detail of the seal and spring of FIG. 8 in a loosely assembled position according to an exemplary embodiment.

FIG. 12a is a longitudinal sectional view of another embodiment utilizing a radially biased hybrid band having an inclined surface to impose an axially biasing force to urge the flange of the coupling member into the flange of the post;

FIG. 12b is an enlarged view of a pair of face-to-face recesses formed in the sleeve and coupling member of the connector showing movement of the hybrid band from a tightened state (shown in dashed lines) to a loose state (shown in solid lines) wherein the coupling member is biased against the flange 16 of the post 12.

FIG. 13 is an enlarged view of the recess employing another embodiment of the hybrid arcuate bridge member;

FIG. 14 is an enlarged view of another embodiment of the inventive connector including a recess having inclined surfaces to effect an axial biasing force on the flange of the coupling member to urge the flange of the post into contact with an interface port.

### DETAILED DESCRIPTION

Various embodiments disclosed herein provide for a novel and improved compression connector for cables, and specifically, for coaxial cables. For example, in F-connectors designed specifically for connection to a port or terminal of an entertainment or security system, an electrically conductive, watertight seal is disclosed herein for use in combination with an annular coupling member to maintain optimum electrical conductivity between the coaxial cable and port. In one embodiment, an electrically conductive seal is in the form of a rubber or resilient 0-ring containing electrically conductive particles and is mounted so as to be compressible between a port and the end of the cable connector.

In another embodiment, a conductive spring is utilized in combination with an elastomeric seal and a spring mounted between opposing or confronting surface portions of an outer connector sleeve and a coupling member. In still another embodiment, a conductive spring in the form of an arcuate band is mounted between the opposing or confronting surface portions of the connector sleeve and coupling member, but spaced or removed away from the seal member.

Coaxial cables often include inner and outer concentric conductors separated by a dielectric insulator and encased or covered by an outer jacket of a rubber-like material. Numerous end connectors have been devised to effect a secure mechanical and electrical connection between a connector assembly (e.g., a coaxial cable connector) and the end of the coaxial cable, typically by having the inner conductor and dielectric insulator extend through an inner sleeve of the connector assembly while the outer conductor and jacket are inserted into an annular space between the inner sleeve and an outer sleeve. The outer sleeve is then crimped in a radially inward direction or otherwise compressed, etc. to securely clamp the end of the cable within the connector, and a fastener such as a nut on the opposite end of the connector is then connected to a port or terminal.

U.S. Pat. No. 5,975,949 illustrates a coaxial cable connector of the type described and with a somewhat modified form of watertight seal which is interposed between confronting surface portions of a flange at the end of the inner sleeve and the end of a coupling member which extends from the post or terminal. Nevertheless, in certain applications, there is a continuing need for a compression-type coaxial cable and connector which can achieve improved. mechanical and electrical connection between the coaxial cable connector and the port or terminal including a novel and improved watertight but electrically conductive seal which will maintain the necessary conductivity and which is mounted in such a way as to resist accidental loosening of the coupling member between the connector and port or terminal.

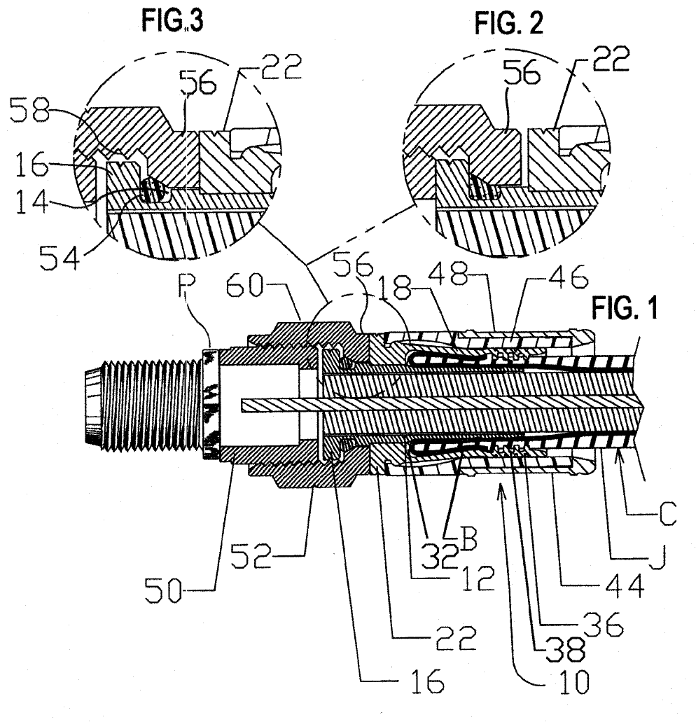

Referring in more detail to the drawings, one embodiment is illustrated in FIGS. 1 to 3 wherein the assembly is made up of a connector 10 for connecting a first electrically conductive bridge member, such as, a standard coaxial cable C to a second electrically conductive member, such as, a port or terminal P on different components of a home entertainment system, etc. According to an exemplary embodiment, connector 10 includes an elongated thin-walled inner sleeve 12 or post at an entrance end. In some embodiments, sleeve 12 increases in thickness along a mid-portion into an external groove 14 and terminates in an external shoulder 16. Connector 10 further includes an outer thin-walled sleeve 18 extending from a point slightly beyond the sleeve 12 at the entrance end, and in some embodiments being of uniform thickness along its greater length. Sleeve 18 may be provided with an external groove which is flanked at one end by external shoulder 22.

In one embodiment, inner and outer sleeves 12 and 18 extend rearwardly from the entrance end in spaced concentric relation to one another so as to form an annular space 32 therebetween for insertion of a standard cable C in a manner to be described. Inner sleeve 12 may be of substantially uniform wall thickness for its greater length and have a plurality of axially spaced, annular serrations along its outer wall surface and toward the entrance end. Outer sleeve 18 may be thin-walled along its greater length, but gradually increases in thickness to define an external convex surface portion 36 and which has a plurality of axially spaced sealing rings or grooves 38 in accordance with U.S. Pat. No. 5,501,616.

According to an exemplary embodiment, a crimping ring 44 (compression member, etc.) of generally cylindrical configuration may be configured to extend over at least a portion of outer sleeve 18, and may have a length generally corresponding to the length of the thin-walled sections of outer sleeve 18. In some embodiments, member 44 includes an inner liner 46 that may be of uniform thickness and diameter throughout which terminates in opposed beveled ends, and an outside band 48 that may be of generally uniform thickness and diameter throughout at least a portion of its length and may be coextensive with inner liner 46. In some embodiments, inner liner 46 is composed of a material having a slight amount of give or resilience; and outer band 48 is composed of a material having little or no give or compressibility, such as, a brass material. Inner liner 46 and band 48 may in some embodiments be of substantially corresponding thickness, and inner liner 46 may be mounted in a press-fit or other fashion inside of band 48, with its inner wall surface being of a diameter corresponding to or slightly greater than the outer diameter of outer sleeve 18 at its entrance end. Inner liner 46 may in some embodiments have an inner diameter less than the convex surface portion 36 on outer sleeve 18 so that when ring 44 is axially advanced, ring 44 will impart inward radial deformation to the convex surface portion of outer sleeve 18 causing it to be contracted, as illustrated in FIG. 1, into engagement with the cable C.

The cable C is connected to the connector 10 in the usual manner by first preparing the leading end of the cable to fold the braided layer B over the end of the jacket J, as illustrated in FIG. 1. Compression ring 44 is aligned, as illustrated in FIG. 1, with the end of connector 10, following which the leading end of cable C is advanced through compression ring 44 and into annular space 32 formed between inner sleeve 12 and outer sleeve 18. A standard compression tool may be used to impart sufficient axial force to advance compression ring 44 over convex surface portion 36 to radially deform or contract that portion of sleeve 18 inwardly, and portion 36 will be bowed or deformed, etc. in a radially inward direction, as shown in FIG. 1, and cause jacket J, as well as at least a portion of braided layer B, to be compressed slightly between inner and outer sleeves 12 and 18.

Once the installation is completed, a starter guide, if used, may be removed from the end of the pin conductor and discarded. A compression tool (not shown) is shown and described in detail in U.S. Pat. No. 6,708,396 which is incorporated by reference herein. While the Figures herein generally show a compression member moving axially over a compressible outer sleeve to secure a coaxial cable relative to the coaxial connector, other forms of securing the cable may be used, such as a deformable locking sleeve being axially compressed within a connector body to similarly secure the coaxial cable in position. All such alternative embodiments are to be understood to be within the scope of the present disclosure.

Port or terminal may have a hollow externally threaded extension 50 to receive the inner conductor pin of the cable C and is coupled to the end of the connector 10 by a coupling member, such as, a nut 52 which is internally threaded with threads 58 to mate with the external threading on extension 50 whereby to draw extension 50 toward and/or into engagement with flange 16 on the end of inner sleeve or post 12 of connector 10. In order to provide for improved conductivity between connector 10 and port P, and in particular to maintain the necessary conductivity notwithstanding a poor connection or loosening of the coupling members between the conductor pin and port P. an electrically conductive, watertight annular seal 54 (e.g., a conductive O-ring, resilient member, elastomeric member, etc.) may mounted in a groove 14 adjacent to flange 16 and coupling member 52.

Coupling member 52 may extend forwardly from an end wall 56 over and beyond flange 16, and may be internally threaded to facilitate connection to extension 50 of the port P. Exterior surface 60 of coupling member 52 may be provided with suitable flats (e.g., a generally hexagonal configuration, etc.) for engagement by a wrench or other suitable tool to rotate coupling member 52 independently from the remainder of connector 10.

According to an exemplary embodiment, seal 54 may take the form of an O-ring, and may be composed of an elastomeric material having electrically conductive particles uniformly or non-uniformly distributed within seal 54, one example of such particles being carbon fibers. In the loosely assembled position shown in FIGS. 1 and 3, seal 54 is in a relaxed state and not necessarily in direct contact with the adjacent or confronting surfaces of the flange 16 and end wall 56 of the coupling member 52. However, when the coupling member 52 is rotated to draw the port into contacting relation to the forward end of flange 16 opposite to seal 54, end wall 56 will be drawn toward the opposite surface of flange 16 to compress the seal 54 between the end wall 56 and flange 16, as shown in detail in FIGS. 2 and 3. As a result, a conductive path is established between inner sleeve 12 and end wall 56 of coupling member 52.

It will be appreciated that seal 54 will maintain the necessary contacting relationship between the fronting surfaces notwithstanding a slight loosening between the parts, such as, as a result of temperature changes or wear. An important advantage of utilizing a watertight, conductive seal as one member or unit is that it serves a dual function of providing a watertight seal which is also electrically conductive; and at the same time the seal diameter may be varied to compensate for differences in connector size and the gap between the confronting surfaces of flange 16 and end wall 56, as well as variations in type of connector.

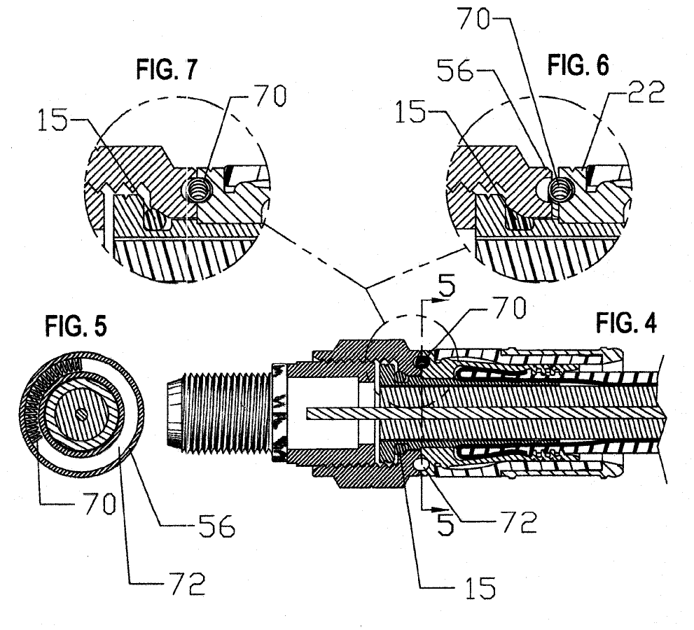

FIGS. 4-7 illustrate another embodiment of an electrically conductive compressible member in the form of a coil spring 70, which may be mounted under compression in a recessed area or gap 72 between end wall 56 and external shoulder 22 at an end of outer sleeve 18 of connector 10, as illustrated in FIGS. 4-7. According to an exemplary embodiment, shoulder 22 has a squared end surface in normally abutting relation to a squared end surface on end wall 56 of coupling member 52. In some embodiments, rather than to replace a standard O-ring seal 15, spring coil 70 may be mounted under compression within the complementary recessed portions that define gap 72 between the respective confronting surface portions of end wall 56 of coupling member 52 and shoulder 22 of outer sleeve 18.

As best seen from the end view of FIG. 5, it is not necessary for the spring 70 to extend around the entire circumference of the connector body to maintain an electrical ground path between outer sleeve 18 and coupling member 52. However, spring 70 may be of a diameter and under sufficient compression to expand and to maintain electrical contact between sleeve 18 and coupling member 52 (e.g., between the confronting surfaces of sleeve 18 and coupling member 52) notwithstanding slight separation between them, for example, as shown in FIG. 6.

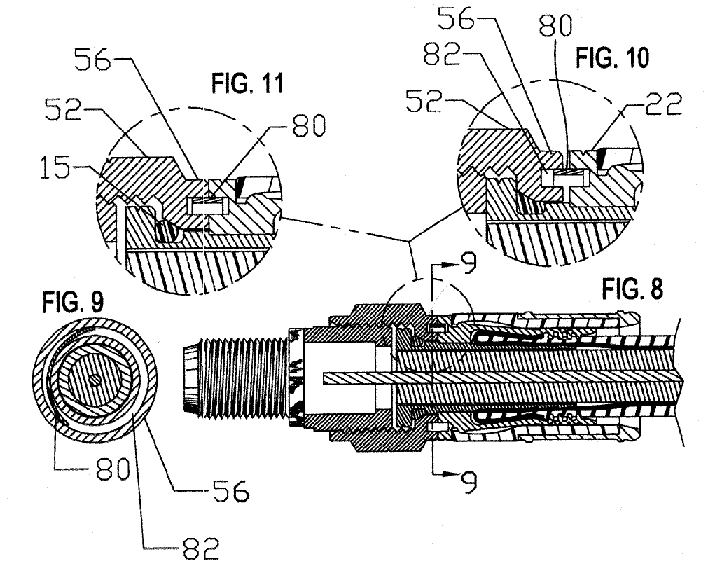

Another embodiment of a conductive ring is illustrated in FIGS. 8-10, wherein like parts to those of FIGS. 1-7 are correspondingly enumerated, and, in a manner similar to that described in connection with the embodiment of FIGS. 4-7, a spring-like, generally circular band 80 may be mounted in a gap 82 defined by annular recessed portions in facing relation to one another in external shoulder 22 of outer sleeve 18 and end wall 56 of coupling member 52. According to an exemplary embodiment, band 80 may be composed of a resilient electrically conductive material such as a metal which is normally flat, but when inserted into gap 82 may be bent, as illustrated

In FIG. 9, so that opposite ends of band 80 yieldingly engage circumferentially spaced surface portions of the outer wall of gap 82, and an intermediate or central portion of band 80 is in contact with the inner wall of gap 82. Also, band 80 may be of a width sufficient to extend along a substantial portion of the width of gap 82. As illustrated in FIG. 10, in some embodiments, band 80 will maintain electrical conductivity between outer sleeve 18 and coupling member 52 notwithstanding separation between the components; and when member 52 is adjacent the end of the sleeve 18, as shown in FIG. 11, band 80 will traverse a substantial width of gap 82.

According to alternative embodiments, the conductive ring members 70 and 80 could be composed of various materials or composite materials which would offer the same characteristics of resiliency and conductivity. For example, one or both of members 70 and 80 could be composed of an inner matrix of plastic with an outer coating of a conductive material, such as, the carbon fibers referred to in connection with FIGS. 1-3. As in the case of helical spring member 70, band 80 does not have to extend throughout the entire annular gap, for example, as illustrated in FIG. 9. In this respect, band 80 would assume a somewhat arcuate configuration when inserted into the gap between the confronting surface portions of the shoulder and end wall 56.

Although the different forms of connector sleeves are illustrated for use in F-connectors as in FIGS. 1 to 11, it will be apparent that they are readily conformable for use with other types of connectors, such as, but not limited to BNC and RCA connectors. It is therefore to be understood that while selected forms of invention are herein set forth and described, the above and other modifications may be made therein without departing from the spirit and scope of the invention as defined by the appended claims and reasonable equivalents thereof.

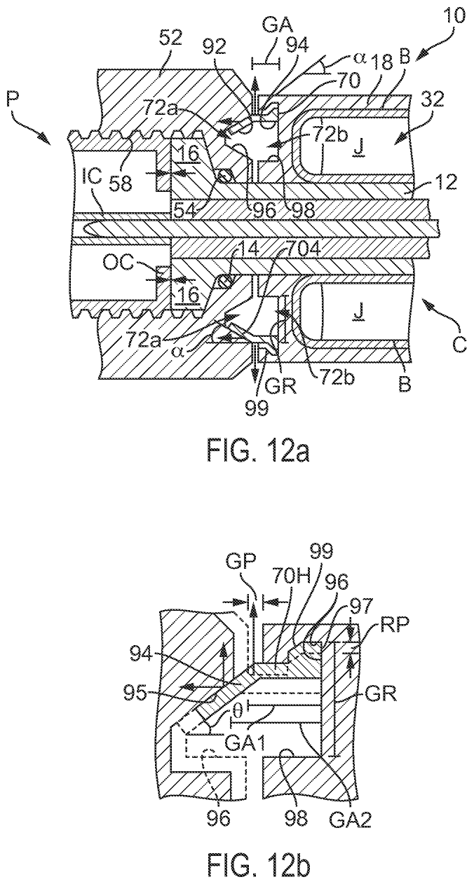

In other embodiments of the disclosure shown in FIGS. 12a-14, the recesses cooperate with the arcuate bridge member to produce an axial force on the coupling member which, in turn, urges the post against the port. As such, the post is “constantly biased” against the port to achieve enhanced grounding of the connector and coaxial cable. More specifically, in FIG. 12a, the recesses 72a, 72b of the coupling member 52 and outer sleeve 18 or body member define internal contact surfaces 92 and 94, respectively, which are axially spaced along the elongate axis 10A of the connector 10. The contact surface 92 defined by the recess 72a of the coupling member 52 diverges outwardly so as to form a cone or frustum shaped surface. The contact surface 94 defined by the sleeve 18 is normal to the elongate axis 10A and parallel to the base of the cone. In the described embodiment, the contact surfaces 92, 94 are separated along the elongate axis 10A by an axial distance GA. In a tightened state the contact surfaces 92, 94 are separated by an axial gap GA1 whereas in a loose state the contact surfaces 92, 94 are separated by an axial gap GA2. In the loose state, only a few threads of the coupling member 52 may be engaged with the threads of the interface port P.

In the described embodiment, each of the recesses 72a, 72b of the coupling member 52 and outer sleeve 18, also define outwardly directed contact surfaces 96 and 98, respectively, which are similarly spaced along the elongate axis 10A. Moreover, the inwardly and outwardly directed contact surfaces 92, 96 of the coupling member 52 and the inwardly and outwardly directed contact surfaces 94, 98 of the outer sleeve 18 each define a radial gap GR. Moreover, at the point where the sleeve and coupling member 18, 52 are separated, the inwardly and outwardly directed contact surfaces 92, 94, 96, 98 are essentially equidistant from the elongate axis 10A of the connector 10.

The conductive band or arcuate bridge member 70H is similar to the previously described flat band embodiment, however, the arcuate bridge member 70H defines an outwardly directed contact surface 95 (See FIG. 12b) which complements the shape of at least one of the internal contact surfaces 92, 94. That is, for example, at least a portion of the arcuate bridge member 70H includes a positively inclined surface complementing a negatively inclined surface of the internal contact surface 92 of the coupling member 52. The outward bias of the arcuate bridge member 70H, which is created by spring loading the ends 70E of the band 70H against the internal contact surfaces 92, 94, produces a constant bias of the coupling member 52 against the flange 16 of the post 12. This, in turn, urges the post 12 into electrical contact with the outer conductor OC of the port P. On the other hand, the positively inclined or sloping surface 95 of the arcuate bridge member 70H causes the opposite side or portion of the band 70H to abut, i.e., to be urged against the radially or vertically aligned contact surface 96 of the sleeve 18. As such, an electrical ground path is maintained across the axial gap GP between the coupling member 52 and the sleeve 18.

In the described embodiment, the positively inclined, internal, contact surface 92 of the arcuate bridge member 70H defines an angle a within a range of approximately thirty degrees (30°) to sixty degrees (60°). Similarly, the internal contact surface 92 of the coupling member 52 defines a negatively sloping surface within the same thirty to sixty degree range (30°-60°).

While the internal contact surface 94 of the outer sleeve 18 is shown to be parallel to the elongate axis 10A, or a straight angle, it should be appreciated that the internal contact surface 94 may form other complementary configurations. For example, the arcuate bridge member 70H may include an outwardly directed flange 97 for being received within an annular notch or groove in the internal contact surface 94 of the outer sleeve 18. The notch or groove 99 may function to retain the arcuate bridge member 70H within the outer sleeve of the connector 10, or to preposition the arcuate bridge member 70H during transport and assembly of the connector 10.

The arcuate bridge member 7 spans the gap GP (FIG. 12b) between the coupling member 52 and the outer sleeve 18. Additionally, the arcuate bridge member 70H spans the radial gap GR between one of the outwardly directed contact surfaces 96, 98 and one of the internal contact surfaces 92, 94 of the coupling member 52 and outer sleeve 18. As such, the band 70H facilities grounding when the axial and radial gaps GA, GR vary in dimension and placement. That is, the arcuate bridge member 70H enables the coupling member 52 and the sleeve 18 to separate and/or become radially misaligned, the outer sleeve 18 being shifted radially with respect to the coupling member 52. In FIG. 12b, the arcuate bridge member 70H is radially spaced from the contact surface 96 such that an initial radial gap RP is created. The gap RP is produced to allow the arcuate bridge member 70H to move radially, thereby allowing the complementary conical surfaces 94, 95 to slide axially relative to each other.

In the described embodiment, the arcuate bridge member 70H may be fabricated from a resilient conductive material such as a copper alloy having a mixture of copper, tin and steel to provide the proper spring stiffness. Alternatively, the arcuate bridge member 70H may be fabricated from a thermoplastic having a conductive coating bonded to the outwardly directed contact surface of the arcuate bridge member 70H.

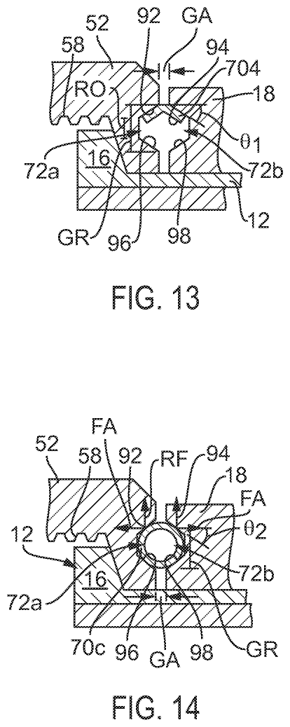

In FIGS. 13 and 14, each of the recesses 72a, 72b, may include conical or frustoconical surfaces on each of the inwardly and outwardly directed contact surfaces 92, 96 of the coupling member 52 and the inwardly and outwardly directed contact surfaces 94, 98 of the outer sleeve 18. As used herein “conical surface” means any frustoconical, sloping or inclined surface capable of producing an axial component of force when reacting a radial force. The conical surfaces 92, 94, 96, 98 may form a V-shaped or U-shaped recess having converging side surfaces 92, 94, 96, 98 separated by a radial distance RD (see FIG. 13). In FIG. 13, the internal contact surfaces 92, 94 each define an angle θ₁ which complements the outwardly facing contact surface of the arcuate bridge member 70H. In FIG. 14, a coil spring 70C substitutes for the arcuate bridge member 70H, and relies on the deformation of each turn of the coil to (i) span the axial gap for grounding proposes, and (ii) produce a biasing force on the coupling member 52 to urge the post 12 against the port P. Whether a arcuate bridge member 70H or coil spring 70C are used to electrically span the axial gap GA, the sloping inwardly and outwardly facing contact surfaces 92, 94, 96, 98 produce axial components FA of the radial force RF are additive to enhance the biasing force produced by the arcuate bridge member 70H or coil spring 70C.

Additional embodiments include any one of the embodiments described above, where one or more of its components, functionalities or structures is interchanged with, replaced. by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A coaxial cable connector, comprising:
a post comprising a first flange and defining an elongate axis;
a sleeve positioned around the post and comprising a second flange, the post and the sleeve configured to retain an end of a coaxial cable;
a coupling member comprising a third flange and positioned around the forward end of the post; the flanges of the sleeve and the coupling member forming recesses each defining an internal contact surface, the internal contact surfaces separated by an axial gap;
a grounding member, disposed in combination with one of the sleeve and the coupling member and biased outwardly against at least one of the internal contact surfaces, the grounding member configured to produce a force component in a radial direction, the radial force causing the grounding member to bridge the axial gap between the internal contact surfaces and maintain electrical grounding between the sleeve and the coupling member even when the sleeve does not electrically contact the coupling member.

2. The coaxial cable connector of claim 1 wherein the grounding member is integral with one of the sleeve and the coupling member.

3. The coaxial cable connector of claim 1 wherein the grounding member is non-integral with one of the sleeve and the coupling member.

4. The coaxial cable connector of claim 1 at least one of the internal contact surfaces of the sleeve and the coupling member define an inclined surface.

5. The coaxial cable connector of claim 1 wherein at least one of the internal contact surfaces of the sleeve and the coupling member define an inclined surface.

6. The coaxial cable connector of claim 5 wherein the external contact surface of the grounding member defines a complementary inclined surface.

7. The coaxial cable connector of claim 1 wherein the grounding member is connected to one of the sleeve and the coupling member by an outwardly directed flange received within an annular groove of one of the sleeve and the coupling member.

8. The coaxial cable connector of claim 1 wherein the grounding member comprises a C-shaped arcuate bridge member.

9. The coaxial cable connector of claim 1 wherein the external contact surface of the grounding member defines a frustum-shaped surface.

10. The coaxial cable connector of claim 1 wherein the internal contact surfaces collectively define a V-shaped cross-sectional configuration.

11. The coaxial cable connector of claim 1 wherein the internal contact surfaces of the sleeve and the coupling member are radially equidistant from the elongate axis at the location of the axial gap.

12. A connector comprising:
a post comprising a first flange and defining an elongate axis;
a sleeve positioned around the post and comprising a second flange, the post and the sleeve configured to retain an end of a coaxial cable;
a coupling member comprising a third flange and positioned around the forward end of the post; the flanges of the sleeve and the coupling member forming recesses defining inwardly-facing internal contact surfaces separated by an axial gap, each annular recess having an outwardly-facing external contact surface which, in combination with the respective internal contact surface, defines a radial gap; and
a grounding member disposed in combination with one of the sleeve and the coupling member, the grounding member comprising an outwardly-facing external contact surface configured to engage the inwardly-facing internal contact surface of one of the sleeve and the coupling member, the outwardly-facing external contact surface being biased radially outwardly against the inwardly-facing internal contact surfaces to maintain an electrical ground path therebetween even when the sleeve does not electrically contact the coupling member.

13. The connector of claim 12 wherein the grounding member is integral with one of the sleeve and the coupling member.

14. The connector of claim 12 wherein the grounding member is non-integral with one of the sleeve and the coupling member.

15. The connector of claim 12 wherein the recesses are disposed in substantially face-to-face relation.

16. The connector of claim 12 wherein the grounding member comprises an arcuate conductive bridge portion which spans an arc greater than about one-hundred and eighty degrees (180) around the elongate axis of the post.

17. The connector of claim 16 wherein the arcuate conductive bridge portion is substantially C-shaped.

18. The connector of claim 12 wherein the internal contact surfaces are radially equidistant from the elongate axis at the location of the axial gap.

19. The connector of claim 18 wherein the grounding member includes an arcuate hand having one portion which contacts an internal contact surface of one of the sleeve and the coupling member and another portion which contacts an external contact surface of one of the sleeve and the coupling member so as to electrically span the radial gap.

20. The connector of claim 12 wherein the ends of the hand contact the internal contact surfaces of the recesses and wherein an intermediate portion of the band contacts the outwardly facing contact surface of the band to electrically span the radial gap.

21. The connector of claim 12 further comprising an annular seal interposing the third flange of the coupling member and the first flange of the post.
